(19) United States
(12) Patent Application Publication
(10) Pub. No.: US 2025/0174949 A1
(43) Pub. Date: May 29, 2025

(54) CARBON BRUSH AND METHOD OF SUPPLYING POWER TO A CARBON BRUSH SENSOR

(71) Applicant: AB Dynamoborstfabriken, VADSTENA (SE)

(72) Inventors: Jonathan Stenberg, Linköping (SE); Erik Björklund, Motala (SE)

(21) Appl. No.: 18/834,180

(22) PCT Filed: Jan. 31, 2023
(86) PCT No.: PCT/EP2023/052264

§ 371 Date: Jul. 29, 2024

(30) Foreign Application Priority Data
Jan. 31, 2022 (SE) 2250092-0

(51) Int. Cl. H01R 39/58

(52) U.S. Cl. CPC H01R 39/58

(57) ABSTRACT

A carbon brush (11) for use in a sliding contact in a dynamoelectric machine, comprises a brush body (111), formed of an electrically conducting low friction material, the brush body having a contact surface for providing said sliding contact, a brush sensor (113), for detecting at least one parameter relating to the carbon brush, first and second electrical connections (41, 42), which are spaced apart along a current path through said carbon brush (11), such that a voltage drop is present between said first and second electrical connections (41, 42) when a current is conducted through said carbon brush (11), and an energy harvesting device (4) configured to act as a power source, by utilizing the current and the voltage drop. for providing electrical energy for driving said brush sensor (113). The energy harvesting device (4) is electrically connected to said first and second electrical connections (41, 42). There is disclosed a system comprising such carbon brush and a method of supplying power to a brush sensor.

### TECHNICAL FIELD

The present disclosure relates to a carbon brush for use in a dynamoelectric machine, such as an electric motor or an electric generator, and to a method of supplying power to a carbon brush sensor. The carbon brush sensor may be provided for measuring at least one parameter relating to the carbon brush, such as brush length, brush temperature, brush vibration, brush voltage or brush current.

### BACKGROUND

It is well known that dynamoelectric machines, such as motors or generators, in particular dc machines, comprise so-called “brushes” to provide contacts between rotating and fixed parts of the machine. Each such brush will be in sliding contact with a commutator or slip ring, for transferring electric power across the sliding contact. At such contact, the brush will slide against a smooth surface, typically of metal. It is thus desirable to achieve low electric resistance and low friction. Such materials are known from e.g. EP2681812A1. The contacts are typically designed with the brush being a sacrificial part, which is to be replaced when it has worn down to a certain extent. To this end, the brush may be formed of a material having good conductivity and low friction. In particular, a brush may comprise a sintered body comprising carbon and a metal, such as copper and/or silver. Such brushes are generally referred to as “carbon brushes”.

A dynamoelectric machine may comprise many such brushes. Large motors or generators may comprise hundreds of such brushes, each of which being subject to wear and thus needing replacement at regular intervals. Hence, an important aspect of the maintenance of any dynamoelectric machine is to check and replace carbon brushes.

It is known from e.g. U.S. Pat. No. 6,359,690B1 and DE10257623A1 to automatically monitor the wear of carbon brushes by measuring their length, either continuously or at certain intervals, and to use thus generated length data to estimate remaining service life of each brush.

WO2019179886A1 discloses a carbon brush for use in a dynamoelectric machine, which carbon brush is provided with a brush length measuring device and a communication device that communicates wirelessly with a brush monitoring device. The measuring device and the communication device need electric power in order to operate. Hence, the measuring device and the communication device would need to be connected to a power supply via a power cable, or the carbon brush would need to be fitted with a battery. While power supply through a power cable would render brush installation complicated, with additional wiring being necessary, or with the modification of the dynamoelectric machine to provide a power supply system, battery operation would require regular maintenance not only of the brushes, but also of the batteries.

Hence, there is a need for an improved way of supplying power to a brush sensor and a communication device of a carbon brush.

### SUMMARY

It is an object of the present disclosure to provide an improved way of supplying power to a brush sensor and a communication device of a carbon brush. In particular, it is an object to provide a way of supplying power that makes it possible to retrofit a brush monitoring system in an existing dynamoelectric machine and that does not further complicate maintenance of the dynamoelectric machine.

The invention is defined by the appended independent claims. Embodiments are set forth in the appended dependent claims, in the following description and in the drawings.

According to a first aspect, there is provided a carbon brush for use in a sliding contact in a dynamoelectric machine, comprising a brush body, formed of an electrically conducting low friction material, the brush body having a contact surface for providing said sliding contact, a brush sensor, for detecting at least one parameter relating to the carbon brush, first and second electrical connections, which are spaced apart along a current path through said carbon brush, such that a voltage drop is present between said first and second electrical connections when a current is conducted through said carbon brush, and an energy harvesting device configured to act as a power source, by utilizing the current and the voltage drop, for providing electrical energy for driving said brush sensor. The energy harvesting device is electrically connected to said first and second electrical connections.

A “current path” is defined as a path along which the current to or from the contact surface is conducted.

Electrically conducting low friction materials are known as such, as described in the background section of this document.

The brush sensor needs to be electrically powered by a power source which providing typically a DC voltage in a range of 1.8 V to 5 V. Using a battery as the power source may increase the cost and complexity of the maintenance.

The energy harvesting device can utilize the electric current through the carbon brush to provide power for driving the brush sensor, such that the brush body would be self-sufficient, thereby requiring no battery or external power supply for its function, and thus reduces maintenance cost of the carbon brush.

By utilizing the fact that a voltage drop occurs over at least some of the carbon brush, including its brush body and optionally a power lead extending from the brush body, it is possible to extract sufficient power to supply the brush sensor with power such that the carbon brush with its brush sensor is self-sufficient, thereby requiring no battery or external power supply for its function, which thus reduces maintenance need of the carbon brush.

The energy harvesting device may comprise a first power converter, electrically connected to said first and second electrical connections and configured for converting said input voltage to an intermediate voltage that is greater than said input voltage, and an energy buffer configured to store electrical energy provided by the intermediate voltage.

The energy buffer may be charged with electrical energy. The electrical energy stored in the energy buffer may be discharged for driving the brush sensor.

However, since the output power of the first power converter is very low, a long period of time is needed until the energy charged into the energy buffer is sufficient for performing certain actions. For example, the energy buffer may discharge its stored energy to drive the brush sensor to perform measurement once, or drive the communication device for wireless communication with an external device once. And then, the energy buffer must be charged again for a long period of time until its stored energy is sufficient to perform such action again. That is, the output energy of such energy harvesting device is too low to perform any action frequently. Rather, the action can be performed periodically at a large time interval.

The energy harvesting device may further comprise a second power converter, electrically connected to said first and second electrical connections and configured for outputting an output voltage for driving said brush sensor, and a controller configured to control the second power converter, wherein the controller is configured to switch on when an amount of energy stored in the energy buffer reaches a predetermined value.

Since the output power of the first power converter is very limited, the controller and the second power converter may be used to achieve a second step “power boost” to deliver a stable and usable output power, such that the output power is sufficient for performing certain actions frequently.

For example, the output power can be used to drive the brush sensor to perform measurement frequently, and/or drive a communication device for wireless communication with an external device frequently. The term “frequently” means that the action can be performed at least a couple of times per minutes, or a couple of times per seconds. Thus, an accurate and almost “up-to-date” parameter relating to the carbon brush may be measured and optionally transmitted out.

An absolute value of the intermediate voltage may be larger than an absolute value of the input voltage. An absolute value of the output voltage may be larger than an absolute value of the input voltage.

The electrical energy stored in the energy buffer may later be discharged for driving the controller. The energy buffer may comprise a capacitor and/or a rechargeable battery.

The controller may be a processing circuit, such as an MCU. Firmware may be preloaded in the processing circuit for generating the control signal for controlling the second power converter.

The controller may be switched on when an amount of energy stored in the energy buffer reaches a predetermined value.

The controller may be configured to switch off when a power supplied to the controller is lower than a different threshold value. For example, the controller may need an input voltage of 3.8 V to be switched on. Once switched on, the controller may continue working even if the input voltage drops. When the input voltage is lower than 1.8 V, the controller may be switch off automatically.

Setting the threshold value higher than the minimal required voltage level is beneficial as the controller may have a longer working time period each time when it is switched on. This may improve the stability and robustness of the operation of the second power converter.

The controller may switch on and/or control the second power converter by a control signal. The second power converter may, in response to the control signal, output the output voltage for powering the brush sensor.

The first converter may be a boost converter, which may be a DC to DC converter known for converting a low input voltage to a high output voltage. However, the cost is that its output current is still extremely low as the total energy cannot be increased by such converters.

The energy harvesting device may thus initially convert an extremely low voltage drop (e.g., 20 mV to 100 mV) caused by the electric current (e.g., 100 A) through the carbon brush and an electrical resistance (e.g., 0.2 mΩ to 1 mΩ) of at least a part of the carbon brush, including the brush body and optionally a power lead, such as a cable, to a much higher voltage (e.g., 3.3 V to 5 V), at a cost of a very low intermediate output current.

Subsequently, the intermediate voltage and the electric current may be utilized to generate an output voltage and an output current sufficiently high enough for supplying power to the brush sensor.

The electrical resistance between the first and second electrical connections through the carbon brush may be at most 1 mΩ. Increasing this electrical resistance may increase the input voltage, i.e. the voltage drop, when the electric current is the same. However, increasing this electrical resistance may also reduce the efficiency of the carbon brush, which is designed to have a very low electrical resistance.

The input voltage may be in the order of 10-50 mV, such as about 10-20 mV, about 20-30 mV, about 30-40 mV or about 40-50 mV.

The output voltage for supplying power to the brush sensor may be in the order of 1-10 V, such as about 1-2 V, about 2-3 V, about 3-4 V, about 4-5 V, about 5-6 V, about 6-7 V, about 7-8 V, about 8-9 V or about 9-10 V.

In particular, the input voltage may be about 20-100 mV and the output voltage may be about 3.3 V-5 V.

The controller may be configured to control at least one of a switching frequency and a duty cycle of a control signal for controlling the second power converter.

The controller may output the control signal for switching on and controlling the second power converter. The second power converter may, in response to the control signal, output the output voltage for powering the brush sensor.

The output voltage and output current of the second power converter are the output voltage and output current of the energy harvesting device, which may be controlled by the control signal having a specific switching frequency and/or a specific duty cycle.

A duty cycle is a fraction of one period, i.e. the time for a signal to complete an ON-and-OFF cycle, in which the signal is ON. Duty cycle is commonly expressed as a percentage or a ratio. For example, a 60% duty cycle means that the signal is ON 60% of its period and OFF 40% of its period.

The controller may dynamically control the switching frequency and/or the duty cycle of the control signal depending on actual conditions of the system. For example, when the voltage drop between the first and second electrical connections is high (e.g., 100 mV), the duty cycle of the control signal may be reduced such that the second power converter can generate a more stable output power. When the voltage drop between the first and second electrical connections is low (e.g., 30 mV), the duty cycle of the control signal may be increased such that the second power converter can generate sufficient output power in a certain period.

The switching frequency may be determined based on the second power converter, e.g., which comprises an inductor and a MOSFET connected in series. The switching frequency may be determined based on other factors, including but not limited to the temperature of the different components of the second power converter. Selecting the optimised switching frequency may achieve a better performance of the energy harvesting device.

The second converter may comprise an energy buffer unit and a switch connected in series. The input voltage may be applicable over the energy buffer unit and the switch, such that, when the switch is closed, energy is stored in the energy buffer unit and when the switch is open, energy is discharged from the energy buffer unit. The switch may be controllable by the controller.

The energy buffer unit may be an inductor, such as a coil and the switch may be a transistor, such as a MOSFET transistor, with the controller connected to the gate thereof.

The second power converter may comprise a coil and a field-effect transistor, FET, wherein the FET is electrically connected in series with the coil, between the first and second electrical connections, such that the input voltage is applicable over the coil and the FET. A drain terminal of the FET may be connected to the coil. A source terminal of the FET may be connected to one of the first and second electrical connections. A gate terminal of the FET may be electrically connected to the controller.

The coil may be an inductor suitable for storing electrical energy in a magnetic field when a current flows through it.

The FET may be a MOSFET, metal-oxide-silicon field-effect transistor.

An FET, especially a MOSFET typically has a very low Rds(on) (i.e., drain-source on resistance). In other words, the total resistance between the drain and source terminal of a MOSFET when the MOSFET is ON is very low. Thus, Rds(on) can determine a maximum current through of the MOSFET and is associated with current loss. That is, the lower the Rds(on), the better. Thus, FET, especially MOSFET, has a much better power efficiency than many other types of transistors, such as Bipolar Junction Transistor (BJT).

Another advantage of using FET is that it is voltage driven (e.g., BJT is current driven), which makes FET easy to switch into full saturation mode. Also, since FET is voltage driven, its input power loss is also very low.

Hence, using a FET, especially a MOSFET, to construct the second power converter can achieve a higher power efficiency and a lower power loss.

A channel may be provided between a source terminal and a drain terminal of the FET.

When V_{GS} (the gate to source bias) is larger than Vₜₕ (the threshold voltage of the FET) and V_{DS} (a difference of the drain voltage and source voltage) is less than a difference of V_{GS} and Vₜₕ, the FET is turned on. The channel may be created which allows current between the drain and the source. The FET now operates as a resistor being controlled by the gate voltage relative to both the source and drain voltages.

Thus, the second power converter forms a path parallel to the current path through the carbon brush. The current is equal to the sum of the electric currents through i) the brush body and ii) the second power converter.

Consequently, a tiny portion of the current passing through the carbon brush will be diverted to flow through the second power converter. Exact how much of the current will be diverted can be calculated based the resistances of the current path through the carbon brush, and through the second power converter.

That is, the second power converter may extract electrical energy by diverting a tiny portion of the current through the carbon brush.

The extracted electrical energy is very small (e.g., less than 1% of the total energy through the carbon brush) such that the efficiency of the carbon brush is almost unchanged. However, this extracted electrical energy is sufficient large to drive low energy devices, such as the brush sensor and the communication unit.

The diverted current through the second power converter may store energy in the coil.

When V_{GS} (the gate to source bias) is less than Vₜₕ (the threshold voltage of the FET), the FET is turned off, and there is no conduction between drain and source terminals, i.e. the current between drain and source should ideally be zero.

The second power converter is now an open circuit, and the energy stored in the coil may be released to provide the output voltage for driving the brush sensor.

The first power converter may comprise a first pair of coils for switching a polarity of the input voltage before the first power converter converts the input voltage into the intermediate voltage. The coil may be one coil of a second pair of coils for switching a polarity of the input voltage before the second power converter outputting the output voltage. Hence, a predetermined polarity is achievable by the output voltage regardless of a polarity of said first and second electrical connections.

By providing the pair of coils (inductors), the energy harvesting device can function no matter the electric current is a direct current or an alternating current. Further, the polarity of the input voltage (of said first and second electrical connections) is of no importance as the coils may automatically adjust the polarity of the input voltage such that there is no need to change the direction of how energy harvesting device is connected between the first and second electrical connections. Thus, the carbon brush is more flexible.

The controller is configured to control the FET by controlling a voltage of the gate terminal. When the FET is in an on state, an electric current path may be formed between the first and second electrical connections through the second power converter, parallel to the current path through said carbon brush, such that energy is stored in the coil by a secondary electric current through the second power converter. When the FET is in an off state, said output voltage may be output as a result of the coil discharging the stored energy.

When V_{GS} (the gate to source bias) is larger than Vₜₕ (the threshold voltage of the FET) and V_{DS} (a difference of the drain voltage and source voltage) is less than a difference of V_{GS} and Vₜₕ, the FET is turned on, and the FET is in the on state.

When V_{GS} (the gate to source bias) is less than Vₜₕ (the threshold voltage of the FET), the FET is turned off, and the FET is in the off state. Then, the second power converter is an open circuit, and the energy stored in the coil may provide the output voltage for driving the brush sensor.

Alternatively, the brush sensor may be configured to initiate operation when a sufficient amount of energy is available in the energy buffer.

Alternatively, or as a supplement, the brush sensor may be configured to initiate operation after a sufficient amount of time has passed since a previous initiation of operation of the brush sensor.

The carbon brush may further comprise a controller which is configured to control said initiation of operation of the brush sensor based on said amount of energy is available in the energy buffer and/or based on an amount of time that has passed since a previous initiation of operation of the brush sensor. The first electrical connection may be a connection to the brush body, with the first electrical connection being spaced from the contact surface.

The second electrical connection may be a connection provided further away from the contact surface as seen along the current path.

The brush body may present a wear section that is to be worn away as the brush is used and a non-wear section, that is unaffected by brush wear, and the first electrical connection may be provided in the non-wear section. The non-wear section may be unaffected as a result of the carbon brush being replaced before wear reaches into the non-wear section.

A resistance between said first and second electrical connections may be greater through the energy harvesting device than through the current path through said carbon brush.

The first electrical connection may be spaced from a power lead connection to the brush body.

The first connection may be spaced in a direction parallel with a wear direction of the carbon brush. The first connection may, alternatively, or additionally be spaced in a direction perpendicular to the wear direction.

The second electrical connection may be provided at a power lead extending from the brush body for connection to a power circuit, preferably at a distal portion of such power lead, such as at a power connector.

The power lead may be formed as a rigid rod or as a flexible wire, which may be permanently attached to the brush body so as to provide an optimal electric connection.

The brush sensor may comprise at least one of a brush length measuring device, an accelerometer, a gyroscope, a temperature sensor, a humidity sensor, a pressure sensor, a strain sensor, a voltmeter and a current meter.

The energy harvesting device may be configured to supply power to the controller.

Once switched on, the energy harvesting device may also supply power to the controller, such that the controller may be independent of the first power converter. In other words, once the second power converter starts powering the controller, the first power converter is no longer needed.

The brush sensor may further comprise a communication device for wireless transmission of data generated by the brush sensor.

The communication device may wirelessly communicate other types of data, such that data related to the energy harvesting device, with an external device.

At least the energy harvesting device may be arranged in housing which is separated from at least part of the brush sensor. Hence, as few parts as possible may be arranged on the brush body, such that they can be re-used when the brush body has been replaced.

For example, the brush sensor may comprise a consumable part and a re-usable part, wherein the consumable part is integrated with the brush body and wherein the re-usable part is arranged in the housing. The consumable part may thus be electrically connectable to the re-usable part.

According to a second aspect, there is provided a system comprising a carbon brush as described above and a brush monitor, wherein said brush monitor is configured for wireless communication with the communication device so as to receive data from the brush sensor.

According to a third aspect, there is provided a method of supplying power to a brush sensor in a carbon brush, comprising providing a first and a second power converter between a first and second electrical connection, receiving an input voltage in the form of a voltage drop between the first and second electrical connections along a current path through the carbon brush when a current is conducted through said carbon brush, converting the input voltage in the first power converter to an intermediate voltage, initiating operation of the second power converter when a sufficient amount of energy has been generated by the first power converter, the second power converter storing energy by diverting a part of the current conducted through said carbon brush to pass through the second power converter, and outputting an output voltage from the second power converter for driving the brush sensor by discharging the stored energy.

The method may further comprise storing electrical energy provided by the intermediate voltage in an energy buffer, and initiating operation of the second power converter when said sufficient amount of energy has been stored in the energy buffer.

The method may further comprise controlling at least one of a frequency and a duty cycle of a control signal for controlling the second power converter, such that energy is stored in the second power converter when the second power converter forms a closed circuit, and energy is discharged from the second power converter when the second power converter is an open circuit.

According to a fourth aspect, there is provided a method of supplying power to a brush sensor in a carbon brush, comprising providing a power converter between a first and second electrical connection, receiving an input voltage in the form of a voltage drop between the first and second electrical connections along a current path through the carbon brush when a current is conducted through said carbon brush, converting the input voltage in the first power converter to a storage voltage that is greater than said input voltage, storing electrical energy provided by the storage voltage in an energy buffer, and outputting an output voltage from the energy buffer for driving the brush sensor by discharging the stored energy.

The outputting may be initiated when a sufficient amount of energy has been stored in the energy buffer.

The outputting may be initiated after a sufficient time has passed since a previous outputting.

The outputting may be stopped after the brush sensor has been operated. Consequently, the brush sensor is supplied with power only to such an extent as is needed to make a measurement, and, optionally, to transfer measurement data.

### DRAWINGS

FIG. 1 schematically illustrates a dynamoelectric machine 1 with a brush monitoring system 2 and a power system 3.

FIG. 2 schematically illustrates a carbon brush with a brush sensor and an energy harvesting system.

FIG. 3 schematically illustrates another embodiment of an energy harvesting system.

FIG. 4 is a schematic circuit diagram of a first embodiment of a second power converter.

FIG. 5 is a schematic circuit diagram of another embodiment of the second power converter.

FIG. 6 is a schematic diagram of an operating method.

FIG. 7 is a schematic diagram of an alternative operating method.

### DETAILED DESCRIPTION

In the following, the inventive concept will be described with reference to a dynamoelectric machine, which may be a motor or a generator. It is understood that the corresponding concept may be applied to any carbon brush or corresponding structure for transferring power between a moving part and a stationary part, regardless of whether a relative movement between the moving part and the stationary part is of a rotary or linear nature.

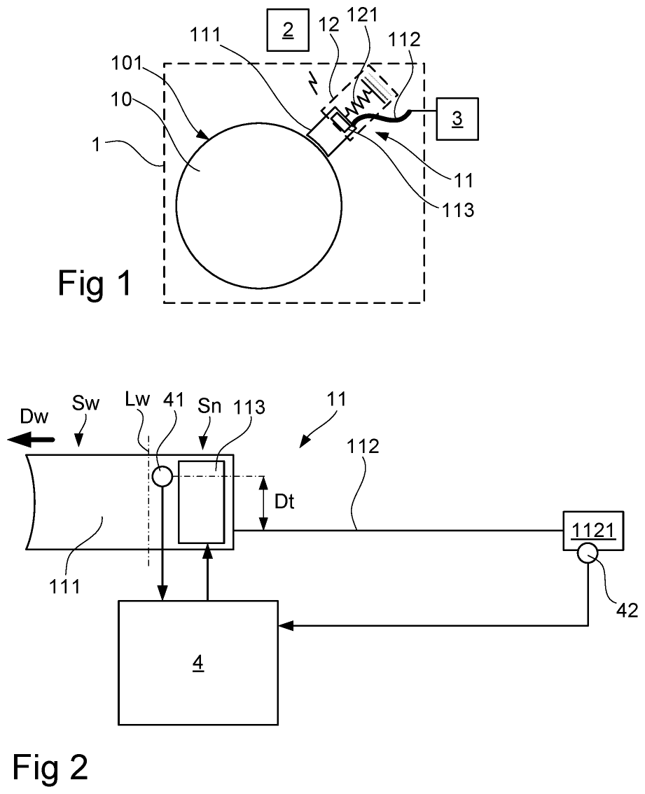

FIG. 1 schematically illustrates a dynamoelectric machine 1 having a moving, such as rotating, part 10 with a contact surface 101, which may be a slip ring or a commutator.

The machine 1 further comprises at least one, conceivably a plurality of, carbon brush(es) 11, which, during operation of the machine 1 contacts the contact surface 101 so as to provide a sliding electrical connection between the moving part and a fixed part.

The carbon brush 11 comprises a brush body 111, to which a power lead 112, which may comprise one or more cables, is attached, for conducting current from the moving part 10 to a power system 3 in the case of a generator, or to the moving part 10 from a power system 3 in the case of a motor. The power system may thus, depending on whether the machine 1 is a motor or a generator, be a system for supplying power to the motor or a system for receiving power from the generator, or in some instances supply power to the generator.

The brush body 111 can be divided into a wear section Sw and a non-wear section Sn, wherein a border between the two sections is designated Lw. The wear section Sw is a section that is intended to be worn away as the brush is worn and the non-wear section Sn is a section that is intended to remain even when the brush body 111 has been completely worn down.

The carbon brush 11 may be arranged in a brush holder 12, which may comprise a biasing element 121 for biasing the brush against the contact surface 101.

The carbon brush 11 further comprises a brush sensor 113, which may be configured for measuring at least one brush related parameter and for wirelessly communicating corresponding data to a brush monitor 2.

The brush sensor 113 may, as non-limiting examples, be configured in accordance with what is disclosed in any of the above-mentioned U.S. Pat. No. 6,359,690B1, DE10257623A1 or WO2019179886A1 for measuring brush length. Alternatively, or additionally, the brush sensor 113 may comprise sensor elements for measuring one or more of brush temperature, pressure, vibration, orientation, humidity, tension, current and voltage in, or relating to, the brush 11.

The brush sensor 113 may further comprise a processing device, a memory and a communication module for receiving, storing and wirelessly communicating measurement data to the brush monitor 2. Such wireless communication may be achieved using one or more specialized protocols or one or more standardized protocols such as Bluetooth®, ZigBee®, NFC or Wi-Fi.

The brush sensor 113 may be mounted on the brush body 111, or it may be wholly or partially provided as a separate device which is connected to the brush body 111 by one or more cables.

The brush sensor 113 may need to be electrically powered by a power source providing typically a DC voltage in a range of 1.8 V to 5 V. The brush monitor 2 may comprise a receiver for receiving data from one or more brush sensors 113, which may be arranged on different brushes in the same machine 1 or in different machines. Hence, one brush monitor 2 may service one machine or a plurality of machines which are installed in proximity of each other.

The brush monitor 2 may comprise a wireless interface, a processor and a memory for receiving, processing and storing information from the brush sensor(s) 113. The brush monitor 2 may further comprise a wide area communication interface, such as a data connection (ADSL, LAN, WAN, 4G, 5G, etc.), through which the brush monitor 2 may communicate with a centralized control and/or monitoring system, such as a SCADA system, which may be provided in the vicinity of the machine 1, or which may be provided at at least one remote location, such as in another facility, in another city and/or in another country.

Referring to FIG. 2, there is illustrated an energy harvesting device 4, which is connected to a carbon brush 11.

The carbon brush 11 comprises the brush body 111, a brush sensor 113 and a power lead 112 with a connector 1121, which may be a standard connector as used for connecting carbon brushes to a power system 3, such as, but not limited to, a spade connector. The power lead 112 may comprise a solid rod type conductor or one or more cables (with one or more filaments) terminating in one or more connectors 1121.

The energy harvesting device 4 may be connected between a brush connecting point 41 at the brush body 111 and a power lead connecting point 42, provided at a distal part of the power lead 112, such as, but not necessarily, at the connector 1121, such that a voltage drop may be provided between the connections 41, 42. To this end, it is desirable that an electric resistance over the energy harvesting device 4 is as small as possible.

The energy harvesting device 4 may be integrated with the brush sensor 113, such as by being provided on the same PCB as the brush sensor and/or in the same housing as the brush sensor 113. Alternatively, the energy harvesting device 4 may be provided as a separate device which may be connected to the brush sensor 113 by one or more cables. In some embodiments, only those parts of the brush sensor which need to be integrated with the brush body may be arranged on the brush body, while other parts, such as the electronics needed for measuring, communication and energy harvesting may all be arranged in a separate housing that is connectable to the parts of the brush sensor that are arranged on the brush body by an interface, such a set of electric connectors. Hence, the electronics may be re-used after replacement of the brush body.

Hence, the brush sensor may comprise a consumable part, such as a sensor body and a re-usable part such as the electronics, wherein the consumable part may be integrated with the brush body and wherein the re-usable part may be arranged in the separate housing. The consumable part may thus be electrically connectable to the re-usable part.

It may be desirable to provide the brush connecting point 41 of the energy harvesting device as far away from the connector 1121 as possible, and thus as close to the wear limit Lw of the carbon brush 11 as possible, such that as much as possible of the carbon brush will serve as resistor. Moreover, the brush connecting point 41 may be provided as far away as possible from where the power lead 112 connects to the body of the carbon brush 11. To this end, the connecting point 41 may be spaced from the power lead 112 in a width direction Dt of the carbon brush 11, perpendicular to a direction Dw along which the brush 11 moves relative to the brush holder as the carbon brush 11 wears.

It may further be desirable to provide as good an electric connection as possible at the brush connecting points 41, 42.

As one example, for the first connecting point 41, a cable end, a connecting rod or a connecting rivet may be integrated into the material of the carbon brush upon it being pressed and/or sintered.

As another example, a connection may be provided using a rivet or a screw providing sufficiently good electric contact with the body of the carbon brush 111.

As yet another example, a connection may be provided by brazing, soldering or welding a cable or contact rod into the material of the carbon brush 111.

As yet another example, a cable end, a connecting rod or a connecting rivet may be tamped into a hole in the body of the carbon brush together with additional brush material.

As yet another example, a cable end, a connecting rod or a connecting rivet may be glued to the body of the carbon brush 111 using electrically conductive glue.

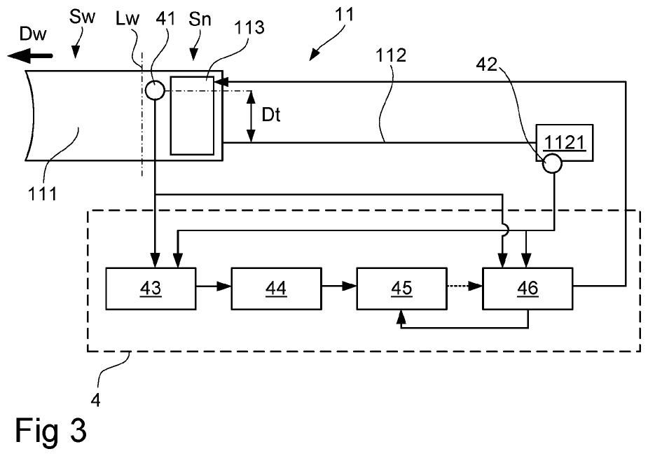

Referring to FIG. 3, there is illustrated an embodiment of an energy harvesting device 4, which comprises additional features.

In particular, the energy harvesting device 4 may comprise a first power converter 43, a second power converter 46, an energy buffer 44 and a controller 45.

Both the first power converter 43 and the second power converter 46 are electrically connected to the first and second electrical connections 41, 42.

The first power converter 43 will now be discussed in detail.

The first power converter 43 may be a power converter configured to step up voltage while stepping down the current. DC-DC power converters can be obtained off-the-shelf with a capacity to increase, as a non-limiting example, a 20 mV voltage to a 3.3 V voltage.

The first power converter 43 may be a DC-to-DC converter known for converting a low input voltage to a high output voltage. However, the cost is that its output current is still low as the total energy cannot be increased by such converters. Thus, even though the first power converter 43 can increase the input voltage, its output power is still very low due to the low output current.

Thus, it may take a very long period of time for charging an energy buffer with the output power of the first power converter 43 for providing sufficient electrical energy for powering the brush sensor 113.The energy harvesting device 4 may need two steps, using the first power converter 43 and the second power converter 46 respectively, and to utilise the electric current through the carbon brush 111 to produce sufficient electrical energy for driving the brush sensor 113 as follows. The energy harvesting device 4 may initially, using the first power converter 43, convert an extremely low voltage drop (e.g., 20 mV to 100 mV) caused by the electric current (e.g., 100 A) through the carbon brush 111 and an electrical resistance (e.g., 0.2 mΩ to 1 mΩ) of at least a part of the carbon brush 111, including the brush body and optionally a part of the power lead 112, to a much higher voltage (e.g., 3.3 V to 5 V), at a cost of a very low intermediate output current. Subsequently, the intermediate voltage may be used to switch on the controller 45, which can switch on and control the second power converter 46. The second power converter 46 may generate an output voltage and an output current sufficiently high enough for supplying power to the brush sensor 113 and to the controller 45.

The second power converter 46 may output sufficient power for driving the brush sensor 113 without waiting for the very long period of time as for the first power converter 43. But the second power converter 46 cannot be switched on by the tiny voltage drop caused by the electric current through the carbon brush 111 and an electrical resistance of at least at least a part of the carbon brush 111, including the brush body and optionally a part of the power lead 112. Thus, the output power of the first power converter 43 may be used to switch on the second power converter 46.

The electrical resistance between the first and second electrical connections through the brush body may be on the order of 1 mΩ. Increasing this electrical resistance may increase the input voltage when the electric current is the same. However, increasing this electrical resistance may also reduce the efficiency of the carbon brush, which is designed to have an extremely low electrical resistance.

The input voltage may be in the order of 10-50 mV, such as about 10-20 mV, about 20-30 mV, about 30-40 mV or about 40-50 mV.

The output voltage for supplying power to the brush sensor 113 may be in the order of 1-10 V, such as about 1-2 V, about 2-3 V, about 3-4 V, about 4-5 V, about 5-6 V, about 6-7 V, about 7-8 V, about 8-9 V or about 9-10 V.

In particular, the input voltage may be about 20-100 mV and the output voltage may be about 3.3 V-5 V. By providing a pair of coils instead of a single coil at the input side, the first power converter 43 may operate regardless of polarity of the input voltage (regardless how the energy harvesting device being connected between the first and second electrical connections).

The energy buffer 44 will now be discussed in detail.

The output of the first power converter 43 may be used to charge the energy buffer 44, such as a rechargeable battery or a capacitor, from which a stable current and/or voltage may subsequently be drawn once a sufficient amount of energy has been stored in the energy buffer 44. Once a sufficient amount of energy has been charged to the energy buffer 44, the latter can be used to switch on the controller 45.

The energy buffer 44 may comprise a switch for controlling the start of the storing electrical energy, e.g., by a capacitor.

The switch may be turned on after a predetermined time period, e.g., 20 s after the first power converter 43 starting outputting the intermediate voltage. Alternatively, the switch may be turned on when a predetermined amount of energy has been outputted (and stored in an additional capacitor) by the first power converter 43.

Using the switch may improve the stability and robustness of the energy harvesting device 4.

The first power converter 43 and the energy buffer 44 can extract energy from the current through the carbon brush and store the energy, respectively, for activating the controller 45.

Since the output power of the first power converter 43 is very limited, the controller 45 and the second power converter 46 may be used to achieve a second step “power boost” to deliver a stable and usable output power, such that the output power is sufficient for performing certain actions frequently. For example, the output power can be used to drive the brush sensor 113 to perform measurement frequently, or drive a communication device for wireless communication with an external device frequently. The term “frequently” means that the action can be performed at least a couple of times per minutes, or a couple of times per second. Thus, an accurate and almost “up-to-date” parameter relating to the carbon brush may be measured and optionally transmitted out.Alternatively, in one embodiment, the energy harvesting device 4 may comprise the first power converter 43 and the energy buffer 44. In other words, the second power converter 46, or the controller 45 is not used. The first converter 43 and the energy buffer 44 can extract energy from the current through the carbon brush and store the energy, respectively, for providing electrical energy for driving the brush sensor 113.

However, without the second step “power boost”, a long time is needed until the energy charged into the energy buffer 44 is sufficient for performing certain actions. For example, the energy buffer 44 may discharge its stored energy to drive the brush sensor 113 to perform measurement once, or drive the communication device for wireless communication with an external device once. And then, the energy buffer 44 must be charged again for a long time until its stored energy is sufficient to perform such action once again. That is, without the second step “power boost”, the output energy of such energy harvesting device is too low to perform any action frequently. Rather, the action can be performed periodically at a large time interval.

However, the time interval between two actions may be too long to meet the requirement of certain usage. For example, if the brush sensor 113 is to measure the temperature of the carbon brush, a more frequent measurement is needed to avoid the carbon brush getting too hot. Otherwise, the temperature of the carbon brush cannot be timely measured and monitored until it is too late.

The controller 45 will now be discussed in detail.

The controller 45 may be a processing circuit, such as an MCU. Firmware may be preloaded in the processing circuit for generating a control signal for controlling the second power converter 46.

The controller 45 may be configured to switch on the second power converter 46. The controller 45 may be switched on when an amount of energy stored in the energy buffer 44 reaches a predetermined value. The controller 45 may be switched on when a power supplied to the controller 45 is equal to or higher than a threshold value. For example, the controller may need an input voltage of 3.8 V to be switched on.

The controller 45 may be configured to switch off when a power supplied to the controller 45 is lower than a different threshold value. Once switched on, the controller 45 may continue working even if its input voltage drops. For example, the controller 45 may continue working until when its input voltage is lower than 1.8 V, then the controller 45 may be switch off automatically.

Setting the threshold value higher than the minimal required input voltage level is beneficial as the controller 45 may have a longer working period each time when it is switched on. This may improve the stability and robustness of the operation of the second power converter 46.

The controller 45 may output a control signal for switching on and controlling the second power converter 46. The second power converter 46 may, in response to the control signal, output the output voltage for powering the brush sensor 113.

The controller 45 may control at least one of a switching frequency and a duty cycle of a control signal for controlling the second power converter 46.

The output voltage and output current of the second power converter 46 are the output voltage and output current of the energy harvesting device 4, which may be controlled by the control signal having a specific switching frequency and/or a specific duty cycle. The controller 45 may dynamically control the switching frequency and/or the duty cycle depending on actual conditions. In response to the control signal having a specific duty cycle and/or a specific switching frequency, the second power converter 46 may output the output voltage for supplying power to the brush sensor 113.

For example, when the voltage drop between the first and second electrical connections is high (e.g., 100 mV), the duty cycle of the control signal may be reduced such that the second power converter 46 can generate a more stable output power. When the voltage drop between the first and second electrical connections is low (e.g., 30 mV), the duty cycle of the control signal may be increased such that the second power converter 46 can generate sufficient output power in a certain period.

The high duty cycle may be at least 75%, at least 85%, or at least 95%.

The low duty cycle may be at most 60%, at most 50%, or at most 40%.

Typical values of the high and low duty cycle are 95% and 50%, respectively.

The switching frequency may be determined based on the second power converter 46, e.g., which comprises a coil (inductor) and a FET (MOSFET) connected in series. The switching frequency may be determined based on other factors, including but not limited to the temperature of the different components of the second power converter 46. Selecting the optimised switching frequency may achieve a better performance of the energy harvesting device.

A typical value of the switching frequency is about 20 KHz.

The second converter 46 will now be discussed in detail.

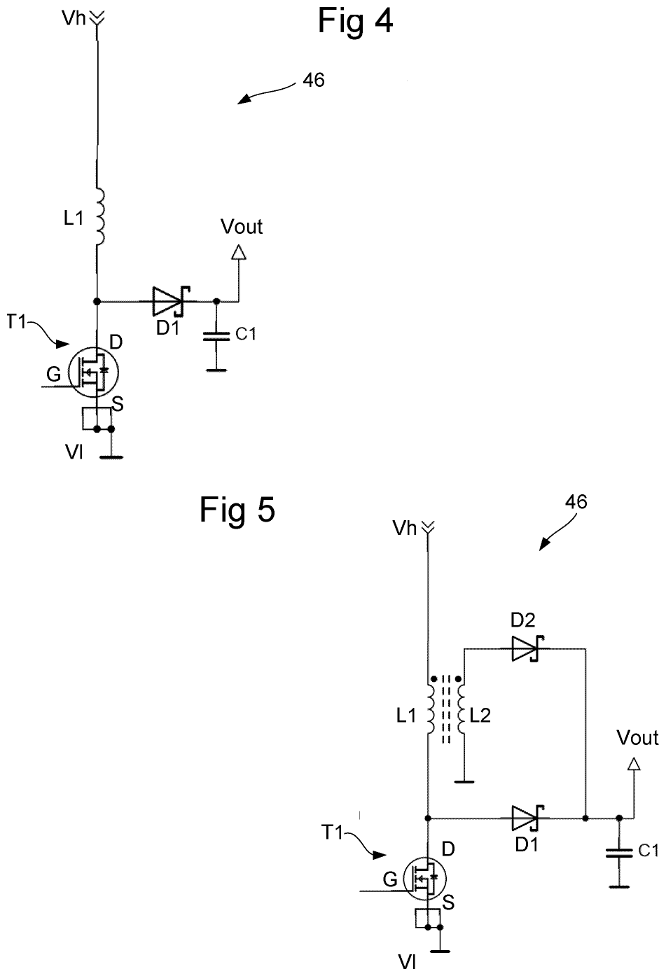

Referring to FIG. 4, a first embodiment of the second power converter 46 of FIG. 4 will be described. This embodiment is suitable for use when the current through the carbon brush is a direct current (DC) having a known direction, i.e. the polarity of the first and second electrical connections is known. Hence, the energy harvesting device may need to be connected differently based on the polarity of the current (i.e. based on the polarity of the first and second electrical connection 41, 42).

In FIG. 4, the second power converter 46 comprises a coil L1 and a transistor T1 connected in series. The second converter 46 is electrically connected to the first and second electrical connections at Vh and Vl, such that the input voltage is applicable over the coil L1 and the transistor T1.

The coil L1 comprises a first terminal configured to be connected to the high voltage Vh, and a second terminal configured to be connected to the transistor T1.

The transistor T1 may comprise a source terminal S connected to the low voltage Vl, a drain terminal D connected to the second terminal of the coil L1, and a gate terminal G connected to the controller 45.

The high voltage Vh may be connected to the first electrical connection 41 of the carbon brush. The low voltage Vl may be connected to the second electrical connection 42 of the carbon brush.

The transistor T1 may be a FET, field-effect transistor. In this example, the transistor T1 is a MOSFET, metal-oxide-silicon field-effect transistor.

When V_{GS} (the gate to source bias) is larger than Vₜₕ (the threshold voltage of the transistor) and V_{DS} (a difference of the drain voltage and source voltage) is less than a difference of V_{GS} and Vₜₕ, the transistor T1 may be turned on. A channel between the source terminal S and the drain terminal D of the transistor T1 may be created which allows current between the drain and the source terminals. The transistor T1 may operate as a resistor, controlled by the gate voltage relative to both the source and drain voltages.

Thus, the second power converter 46 may forms a path parallel to the current path through the carbon brush 11. The current is equal to the sum of the electric currents through i) the brush body and ii) the second power converter 46.

Consequently, a tiny portion of the current otherwise passing through the carbon brush 11 may be diverted to flow through the second power converter 46. Exactly how much of the current will be diverted can be calculated based the resistances of the current paths through the carbon brush and through the second power converter 46.

The diverted current through the second power converter 46 may store energy in the coil L1.

Thus, the second converter 46 may extract electrical energy from the current through carbon brush 111 over the connections 41, 42 in order to supply power to the brush sensor 113.

The extracted electrical energy is very small (e.g., less than 1% of the total energy through the carbon brush 111) such that the conducting efficiency of the carbon brush 111 is almost unchanged. However, this extracted electrical energy is sufficient large to drive low energy devices, such as the brush sensor 113 and the communication unit.

When V_{GS} (the gate to source bias) is less than Vₜₕ (the threshold voltage of the transistor), the transistor T1 is turned off, and there is no conduction between drain and source terminals, i.e. the current between drain and source should ideally be zero. In other words, the second power converter 46 is an open circuit, and the energy stored in the coil L1 may be released and pass through a diode D1 to a capacitor C1 for driving the brush sensor 113.

The controller 45 may control the transistor T1 by controlling a voltage of its gate terminal G. When the transistor T1 is in an on state, an electric current path is formed between the first and second electrical connections through the second power converter, parallel to the current path through said carbon brush, such that energy can be stored in the coil L1 by a secondary electric current through the second power converter 46. When the transistor T1 is in an off state, said output voltage is output as a result of the coil discharging the stored energy.

When V_{GS} (the gate to source bias) is larger than Vₜₕ (the threshold voltage of the transistor) and V_{DS} (a difference of the drain voltage and source voltage) is less than a difference of V_{GS} and Vₜₕ, the transistor T1 is turned on, and the transistor T1 is in an on state.

When V_{GS} (the gate to source bias) is less than Vₜₕ (the threshold voltage of the transistor), the transistor T1 is turned off, and the transistor T1 is in an off state. The second power converter 46 is an open circuit, and the energy stored in the coil L1 may provide the output voltage for driving the brush sensor 113.

When operational, the second converter 46 may also supply electrical energy to the controller 45. This is advantageous as the controller 45 may be self-sufficient and may be independent of the first power converter 43. In other words, once the second power converter 46 starts powering the controller 45, the first power converter 43 is no longer needed.

The diode D1 may be connected between a point connected to the second terminal, such as the low voltage side, of the coil L1 and to the drain terminal D of the transistor T1 and a voltage output terminal for outputting the output voltage Vout. When the transistor T1 is turned on, the diode D1 is off. Consequently, the output voltage Vout is zero. When the transistor T1 is turned off, the energy stored in the coil L1 would be released and turn on the diode D1 for outputting the output voltage Vout.

The capacitor C1 may be connected between the voltage output terminal and ground for storing energy.

An output current of the energy harvesting device 4 (of the second power converter 46) may be proportional to the resistance of the second power converter 46. The resistance of the energy harvesting device may be in the order of tenth of mΩ, such as 30 mΩ.

The input voltage and the resistance of the energy harvesting device 4 may determine the range of the output voltage and output current of the energy harvesting device 4.

The voltage output terminal may be connected directly to the device which it is to drive, such as the brush sensor 113.

Alternatively, the voltage output Vo may be connected to a second energy buffer (not shown) for driving other devices, such as the brush sensor 113.

Referring to FIG. 5, there is illustrated a second embodiment of the second power converter 46. This embodiment is suitable for use when the current through the carbon brush is either a direct current (DC) or an alternating current (AC), having an arbitrary direction, i.e. where one and the same brush may be used regardless of the polarity of its installation, or for an AC or DC application.

As illustrated in FIG. 5, the second power converter 46 comprise the same components connected in a same way as the second power converter 46 of FIG. 4. In addition, the second power converter 46 of FIG. 5 may comprise a pair of coupled coils (inductors) formed by the first coil L1 and at least one second coil L2. A first terminal of the second coil L2 may connect to a diode D2 and a second terminal of the second coil L2 may connect to ground.

The transistor T1 (e.g., MOSFET) here should be able to conduct “backwards” when the polarity of the input voltage is negative. In other words, the transistor T1 should be able to conduct when a positive voltage is applied to the gate terminal and a negative voltage is applied to the drain terminal.

Optionally, a rectifier (D1, D2) may be connected after the second power converter 46 for rectifying the output voltage.

When the transistor T1 is turned on, both the diodes D1 and D2 are off. Consequently, the output voltage Vout is zero. When the transistor T1 is turned off, the energy stored in the pair of coupled coils L1, L2 would be released and turn on either the diode D1 (when the Vh is positive and the Vl is negative) or the diode D2 (when the Vl is positive and the Vh is negative), for outputting the output voltage Vout.

Thus, no matter the polarity of the first and second electrical connections (Vh and Vl), only one of the diodes D1 and D2 would be turn on for outputting the output voltage Vout. Consequently, a pair of coils (inductors) may be provided for input side of the first power converter 43 such that regardless the polarity of the first and second electrical connections, the energy harvesting device may be connected between the first and second electrical connections in the same way and the input voltage would be automatically adjusted to be applicable to the input of the first power converter 43.

Further, since the autopolarity effect is achieved, this embodiment functions even if the current through the carbon brush is alternating current (AC). No matter the current is AC, DC or its polarity is positive or negative, the energy harvesting device can work, which makes the carbon brush flexible. In both embodiments, the second power converter 46 may operate basically by allowing a current through the coil L1 and transistor T1 to build up energy in the coil L1 (and coupled to the second coil L2) while the transistor T1 is in an on state, and to discharge the energy from the coil L1 (and from the second coil L2) while the transistor T1 is in an off state.

By utilizing the current through the carbon brush and the voltage drop present between the first and second electrical connections, the energy harvesting device 4 can act as a power source for providing electrical energy for driving the brush sensor 113.

The energy harvesting device 4 may comprise an amplifier for calculating the current through the carbon brush.

The amplifier may also connect between the first and second electrical connections. When the second power converter 46 is switched off, e.g., for a short period of time, the input voltage can be measured by the amplifier. For example, an ADC (analog-to-digital converter) may be used to accurately calculate the input voltage. Then, the current through the carbon brush can be calculated based on the calculated input voltage and the known resistance between the first and second electrical connections.

Since the resistance may change drastically with temperature, the temperature of the carbon brush measured by the brush sensor may be taken into account to improve the accuracy of the calculation. The amplifier may be a so-called current sense amplifier.

The measured current may be transmitted, e.g., by a communication unit, to a monitor system for monitoring the condition of the carbon brush.

The energy harvesting device 4 may calculate a vibration of the brush body.

As described, the current can be calculated accurately. Since the amplifier is a simple analog circuit, it can be considered to have no delay at all. If the measured current can be sampled fast, the changes of current over time can be followed. It is known that the brush body is typically pushed against the slip ring with a spring arrangement. When the brush body vibrates, the pressure against the slip ring goes up and down and so does the current through the brush body. Therefore, with a rapid and precise measurement of the current, vibrations of the brush body can be accurately derived.

The measured vibration may be transmitted, e.g., by a communication unit, to a monitor system for monitoring the condition of the carbon brush.

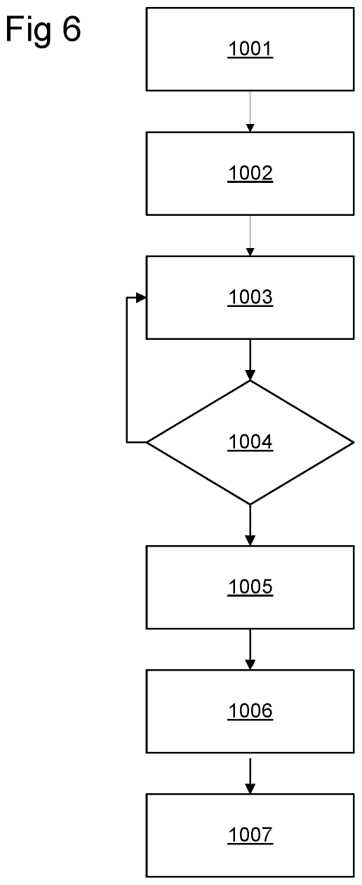

Referring to FIG. 6, an operating method for operation of the energy harvesting device will now be described.

A first and second power converter are provided between a first and second electrical connection.

As a first operation step 1001, an input voltage is applied to the first converter 43, the input voltage being received as a voltage drop between first and second electrical contacts 41, 42 on the carbon brush 11 when a current is conducted through the carbon brush 11. The input voltage may be on the order of 10-100 mV.

The first power converter 43 is then used to convert 1002 the input voltage to an intermediate voltage, which may be on the order of 3-5 V.

The outputted intermediate voltage is applied 1003 to the energy buffer 44. The conversion step 1002 and the voltage application step 1003 may continue until a sufficient amount of energy has been stored in the energy buffer 44. The amount of energy stored in the buffer may be measured 1004 or merely used to trigger the controller 45 once a sufficient amount of energy has been stored in the energy buffer 44.

Once a sufficient amount of energy has been stored in the energy buffer operation of the controller is commenced 1005. Through the operation of the controller, a part of the current conducted through said carbon brush is diverted to pass through the second power converter for storing energy, optionally in the coil L1, and released/discharged for driving the brush sensor, in accordance with a frequency and/or duty cycle determined by the controller 45, which controls the transistor T1.

An output voltage is extracted 1007 from the coil L1 and supplied to the brush sensor 113 and/or to a second energy buffer for storage.

Referring to FIG. 3, it is possible to provide an energy harvesting device 4 having the first power converter 43, but no second power converter 46. This energy harvesting device can be operated such that the first power converter 43 is used to charge the energy buffer 44, whereby the brush sensor 113 may be operated once a sufficient amount of energy has been stored in the energy buffer 44.

In its most simple form, the brush sensor 113 may be configured to initiate operation as soon as there is sufficient energy stored in the energy buffer 44. Hence, no controller will be needed for this function.

Alternatively, the amount of energy stored in the energy buffer 44 may be measured by the controller 45, whereby the controller may initiate operation of the brush sensor 113 when a sufficient amount of energy has been stored in the energy buffer 44.

Alternatively, the controller 45 may initiate operation of the brush sensor 113 at a predetermined time interval, which may be determined based on an estimated operating time of the first power converter 43 for storing a sufficient amount of energy in the energy buffer 44.

Typically, while operation with two power converters 43, 46 may enable a measurement frequency of, for example, 2-3 measurements per minute, it may, in some applications, be sufficient with a measurement frequency of about once every 1-10 minutes, preferably 2-8 minutes or 3-5 minutes, in which case a configuration having a single power converter 43 may be sufficient.

In order to facilitate such operation, optimization of the device may be advantageous by e.g. reducing conductor lengths, eliminating redundant components, reducing leakage currents and improving contact points.

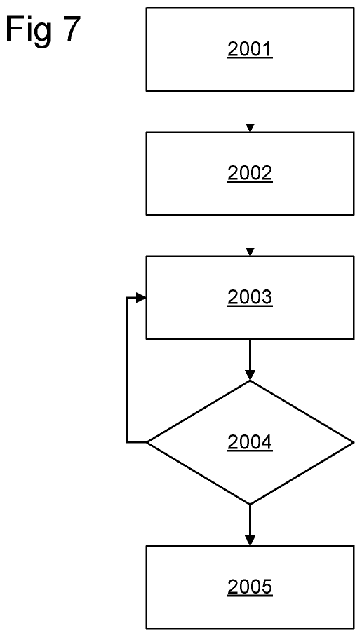

Referring to FIG. 7, operation of an energy harvesting device 4 having only one power converter 43 will be described.

As described with reference to FIG. 6, the first energy converter receives 2001, as a first operation step 2001, an input voltage as a voltage drop between first and second electrical contacts 41, 42 on the carbon brush 11 when a current is conducted through the carbon brush 11. The input voltage may, as a non-limiting example, be on the order of about 10-100 mV, 100-200 mV, 200-500 mV, or even higher.

The first power converter 43 is then used to convert 2002 the input voltage to a storage voltage, which, as a non-limiting example, may be on the order of 3-5 V.

The outputted storage voltage is applied 2003 to the energy buffer 44. The conversion step 2002 and the voltage application step 2003 may continue until a sufficient amount of energy has been stored in the energy buffer 44.

Once a sufficient amount of energy has been stored in the energy buffer 44, operation 2005 of the brush sensor 113 may be triggered.

Alternatively, the amount of energy stored in the buffer may be measured 2004 by a controller 45. Once a sufficient amount of energy has been stored in the energy buffer 44 operation 2005 of the brush sensor 113 may be triggered by the controller 45. Thus, through the operation of the controller 45, operation of the brush sensor 113 can be initiated, such that a measurement relating to the carbon brush can be performed and the resulting measurement data can be stored and/or transmitted.

After a measurement has been made, power to the brush sensor 113 may be turned off, or the brush sensor 113 may be otherwise wholly or partially deactivated, so as not to risk draining the buffer.

The measurement may be followed by a transfer of measurement data to the brush monitor 2. Alternatively, measurement data may be buffered in the brush sensor, whereby data from two or more measurement operations may be transferred simultaneously to the brush monitor 2, whereby a transfer operation, which may require more energy, may be initiated only when a greater amount of energy has been stored in the energy buffer 44.

It is possible to integrate the controller 45 with the brush sensor 113, or to cause operation of the brush sensor to be initiated without the operation of a separate controller 45.

1. A carbon brush for use in a sliding contact in a dynamoelectric machine, comprising:
a brush body, formed of an electrically conducting low friction material, the brush body having a contact surface for providing said sliding contact,
a brush sensor, for detecting at least one parameter relating to the carbon brush, first and second electrical connections, which are spaced apart along a current path through said carbon brush, such that a voltage drop is present between said first and second electrical connections when a current is conducted through said carbon brush, and
an energy harvesting device configured to act as a power source, by utilizing the current and the voltage drop, for providing electrical energy for driving said brush sensor,
said energy harvesting device electrically connected to said first and second electrical connections.

2. The carbon brush as claimed in claim 1, wherein the energy harvesting device comprises:
a first power converter, electrically connected to said first and second electrical connections and configured for converting said input voltage to an intermediate voltage that is greater than said input voltage, and
an energy buffer configured to store electrical energy provided by the intermediate voltage.

3. The carbon brush as claimed in claim 2, wherein the energy harvesting device further comprises:
a second power converter, electrically connected to said first and second electrical connections and configured for outputting an output voltage for driving said brush sensor, and
a controller configured to control the second power converter, wherein the controller is configured to switch on when an amount of energy stored in the energy buffer reaches a predetermined value.

4. The carbon brush as claimed in claim 3, wherein the controller is configured to control at least one of a switching frequency and a duty cycle of a control signal for controlling the second power converter.

5. The carbon brush as claimed in claim 3, wherein the second converter comprises an energy buffer unit and a switch connected in series,
wherein the input voltage is applicable over the energy buffer unit and the switch, such that, when the switch is closed, energy is stored in the energy buffer unit and when the switch is open, energy is discharged from the energy buffer unit, and
wherein the switch is controllable by the controller.

6. The carbon brush as claimed in claim 3,
wherein the second power converter comprises a coil and a field-effect transistor, FET, wherein the FET is electrically connected in series with the coil, between the first and second electrical connections, such that the input voltage is applicable over the coil and the FET, and
wherein a drain terminal of the FET is connected to the coil,
wherein a source terminal of the FET is connected to one of the first and second electrical connections, and
wherein a gate terminal of the FET is electrically connected to the controller.

7. The carbon brush according to claim 5,
wherein the first power converter comprises a first pair of coils for switching a polarity of the input voltage before the first power converter converts the input voltage into the intermediate voltage;
wherein the coil is one coil of a second pair of coils for switching a polarity of the input voltage before the second power converter outputting the output voltage; and
such that a predetermined polarity is achievable by the output voltage regardless of a polarity of said first and second electrical connections.

8. The carbon brush according to claim 6,
wherein the controller is configured to control the FET by controlling a voltage of the gate terminal,
wherein when the FET is in an on state, an electric current path is formed between the first and second electrical connections through the second power converter, parallel to the current path through said carbon brush, such that energy is stored in the coil by a secondary electric current through the second power converter, and
wherein when the FET is in an off state, said output voltage is output as a result of the coil discharging the stored energy.

9. The carbon brush as claimed in claim 2, wherein the brush sensor is configured to initiate operation when a sufficient amount of energy is available in the energy buffer.

10. The carbon brush as claimed in claim 2, wherein the brush sensor is configured to initiate operation after a sufficient amount of time has passed since a previous initiation of operation of the brush sensor.

11. The carbon brush as claimed in claim 9, further comprising a controller which is configured to control said initiation of operation of the brush sensor based on said amount of energy is available in the energy buffer and/or based on an amount of time that has passed since a previous initiation of operation of the brush sensor.

12. The carbon brush as claimed in claim 1, wherein the first electrical connection is a connection to the brush body, said first electrical connection being spaced from the contact surface.

13. The carbon brush as claimed in claim 1, wherein the second electrical connection is a connection provided further away from the contact surface as seen along the current path.

14. The carbon brush as claimed in claim 1, wherein the brush body presents a wear section that is to be worn away as the brush is used and a non-wear section, that is unaffected brush wear, and wherein the first electrical connection is provided in the non-wear section.

15. The carbon brush as claimed in claim 1, wherein a resistance between said first and second electrical connections is greater through the energy harvesting device han through the current path through said carbon brush.

16. The carbon brush as claimed in claim 1, wherein the first electrical connection is spaced from a power lead connection to the brush body.

17. (canceled)

18. (canceled)

19. (canceled)

20. (canceled)

21. (canceled)

22. (canceled)

23. (canceled)

24. A method of supplying power to a brush sensor in a carbon brush, comprising:
providing a first and a second power converter between a first and second electrical connection,
receiving an input voltage in the form of a voltage drop between the first and second electrical connections along a current path through the carbon brush when a current is conducted through said carbon brush,
converting the input voltage in the first power converter to an intermediate voltage,
initiating operation of the second power converter when a sufficient amount of energy has been generated by the first power converter,
the second power converter storing energy by diverting a part of the current conducted through said carbon brush to pass through the second power converter, and
outputting an output voltage from the second power converter for driving the brush sensor by discharging the stored energy.

25. The method as claimed in claim 24, further comprising:
storing electrical energy provided by the intermediate voltage in an energy buffer, and
initiating operation of the second power converter when said sufficient amount of energy has been stored in the energy buffer.

26. The method as claimed in claim 24, further comprising:
controlling at least one of a frequency and a duty cycle of a control signal for controlling the second power converter, such that:
energy is stored in the second power converter when the second power converter forms a closed circuit, and
energy is discharged from the second power converter when the second power converter is an open circuit.

27. A method of supplying power to a brush sensor in a carbon brush, comprising:
providing a power converter between a first and second electrical connection,
receiving an input voltage in the form of a voltage drop between the first and second electrical connections along a current path through the carbon brush when a current is conducted through said carbon brush,
converting the input voltage in the first power converter to a storage voltage that is greater than said input voltage,
storing electrical energy provided by the storage voltage in an energy buffer, and
outputting an output voltage from the energy buffer for driving the brush sensor by discharging the stored energy.

28. (canceled)

29. (canceled)

30. (canceled)
